(19) United States
(12) Patent Application Publication
(10) Pub. No.: US 2024/0051895 A1
(43) Pub. Date: Feb. 15, 2024

(54) COOL BURNING GAS GENERANT FORMULATION FOR AN AIRBAG WITH LOW BURN RATE SLOPE

(71) Applicant: Autoliv ASP, Inc., Ogden, UT (US)

(72) Inventors: Ivan V. MENDENHALL, Providence, UT (US); Jadd SHELTON, Newton, UT (US)

(73) Assignee: Autoliv ASP, Inc., Ogden, UT (US)

(21) Appl. No.: 17/886,536

(22) Filed: Aug. 12, 2022

(51) Int. Cl. C06B 25/34; B60R 21/264; B60R 21/231; C06B 29/16; C06B 41/00

(52) U.S. Cl. CPC C06B 25/34; B60R 21/264; B60R 21/23138; C06B 29/16; C06B 41/00; B60R 2021/26017

(57) ABSTRACT

A gas generant formulation for a side impact airbag that includes a primary fuel, a primary oxidizer, a secondary fuel, and a secondary oxidizer. The secondary fuel includes at least melamine nitrate in an amount that is in a range of about 1.00% by weight to about 10.00% by weight. The secondary oxidizer includes at least potassium perchlorate that is in an amount that is in a range of about 1.00% by weight to about 10.00% by weight. The formulation provides a burn rate that is at least 50 mm/sec at 40 MPa and a burn rate slope that is equal to or less than 0.40.

### FIELD

The present disclosure relates to a gas generating composition for an airbag, as well as to an airbag including the gas generating composition.

### BACKGROUND

This section provides background information related to the present disclosure which is not necessarily prior art.

Airbag systems have been used in vehicles for many years, and significant research has gone into these systems. In general, the goals associated with airbag system research are directed improving performance, reducing a size and weight of the system, and reducing the costs with manufacturing the airbag system. More specifically, significant research has been directed to increasing the functionality of gas generants that are used to inflate the airbag of the airbag system and reducing the cost thereof.

Optimized gas generant performance and subsequent system cost reduction can be achieved by pyrotechnic formulations that can burn with desirable ballistic performance characteristics at a low flame temperature. Such desirable ballistic performance characteristics include a fast burn rate and low burn rate slope. Low flame temperatures and lower burn rate slopes allow for less required airbag cushion reinforcements and reduced wall thickness of the pressure vessel (combustion chamber), effectively reducing system cost and weight. However, the challenge of this approach is to reduce flame temperature and slope while maintaining a high enough burning rate to inflate the airbag cushion in the required time.

The heat sink in the inflator is typically in the form of a metal screen pack which also serves to filter solid combustion residue from the gas stream. In an efficient inflator design, the amount of screen pack used would be sufficient to effectively filter the solid combustion products from gas stream and cool the gas from combustion flame temperatures to a lower desired temperature that will cause minimal damage to the airbag. The desired combustion flame temperature for a “fast and cool” gas generant formulation used in a side application is 1800K-1950K.

Current technology for side impact inflator applications is to use an alkali metal perchlorate co-oxidizer such as potassium perchlorate in conjunction with a basic copper nitrate oxidizer, guanidine nitrate fuel, and an optional co-fuel. The burning rate achieved is a function of the amount of potassium perchlorate used. Unfortunately, the amount of potassium perchlorate used is also directly proportional to the combustion flame temperature. Reducing the amount of potassium perchlorate in the formulation would cool the flame temperature and desirably reduce the amount of condensable potassium chloride gas in the combustion products. Gaseous potassium chloride can pass through the filter and condense then form a solid in the cushion itself making it a challenge to meet customer limits for airborne particulates. However, reducing the amount of potassium perchlorate to hit the target flame temperatures would reduce the burning rate enough that it would no longer be useful in a side impact application, for example. An additive, that when added to the other ingredients of the formulation, reduces the combustion flame temperature, and has a positive impact on the ballistics that in turn enables reduction of the amount of potassium perchlorate in the formulation would be a “fast and cool” solution and an improvement in the art.

### SUMMARY

This section provides a general summary of the disclosure, and is not a comprehensive disclosure of its full scope or all of its features.

According to a first aspect, the present disclosure provides a gas generant formulation for a side impact airbag that may include a primary fuel; a primary oxidizer; a secondary fuel that may include at least melamine nitrate, an amount of the melamine nitrate being in a range of about 1.00% by weight to about 10.00% by weight; and a secondary oxidizer that may include at least potassium perchlorate, an amount of the potassium perchlorate being in a range of about 1.00% by weight to about 10.00% by weight, wherein a burn rate of the formulation is at least 50 mm/sec at 40 MPa and a burn rate slope is equal to or less than 0.40.

According to the first aspect, the primary fuel may include at least guanidine nitrate, and an amount of the guanidine nitrate may be in a range of about 35% by weight to about 55% by weight.

According to the first aspect, the primary oxidizer may include at least basic copper nitrate, and an amount of the basic copper nitrate is in a range of about 25% by weight to about 50% by weight.

According to the first aspect, the formulation may further include at least one additive in an amount up to about 11.0% by weight that is configured to cool a gas temperature yielded by the formulation, improve slagging of the formulation, or act as a press aid of the formulation.

According to the first aspect, the formulation may include the additive that improves slagging, and the additive that improves slagging may include at least one of a metal oxide and/or a metal hydroxide.

According to the first aspect, the formulation may include the additive that is configured to act as a press aid, and the press aid may include at least one of a lubricant and/or a release agent. The lubricant may include at least one of molybdenum disulfide and graphite, and the release agent may include at least one of calcium stearate and magnesium stearate.

According to a second aspect of the present disclosure, there is provided a gas generant formulation for a side impact airbag that may include a primary fuel that includes at least guanidine nitrate; a primary oxidizer that includes at least basic copper nitrate; a secondary fuel that includes at least melamine nitrate, an amount of the melamine nitrate being in a range of about 5.00% by weight to about 10.00% by weight; and a secondary oxidizer that includes at least potassium perchlorate, an amount of the potassium perchlorate being in a range of about 5.00% by weight to about 10.00% by weight, wherein a burn rate of the formulation is at least 50 mm/sec at 40 MPa and a burn rate slope is equal to or less than 0.40.

According to the second aspect, an amount of the guanidine nitrate may be in a range of about 35% by weight to about 55% by weight.

According to the second aspect, an amount of the basic copper nitrate may be in a range of about 25% by weight to about 50% by weight.

According to the second aspect, the formulation may further include at least one additive in an amount up to about 11.0% by weight that is configured to cool a gas temperature yielded by the formulation, improve slagging of the formulation, or act as a press aid of the formulation.

According to the second aspect, the formulation includes the additive that improves slagging, and the additive that improves slagging may include at least one of a metal oxide and a metal hydroxide.

According to the second aspect, the formulation includes the additive that is configured to act as a press aid, the press aid may include at least one of a lubricant and/or a release agent, and the lubricant may include at least one of molybdenum disulfide and graphite, and the release agent may include at least one of calcium stearate and magnesium stearate.

Further areas of applicability will become apparent from the description provided herein. The description and specific examples in this summary are intended for purposes of illustration only and are not intended to limit the scope of the present disclosure.

### DETAILED DESCRIPTION

Example embodiments will now be described more fully with

reference to the accompanying drawings.

The present disclosure provides a gas generating composition. Gas generating compositions, also known as propellants, gas-generating materials, and pyrotechnic materials are used in inflators of airbag modules that are used in vehicle occupant inflatable restraint systems. Selection of a gas generating composition or material involves various factors, including meeting current industry performance specifications, guidelines, and standards; generating safe gases or effluents; handling safety of the gas generating materials; stability of the materials over longer periods of time; and cost-effectiveness in manufacture, among other considerations. It is preferred that the gas generation compositions are safe during handling, storage, and disposal.

Improved gas generator performance in an inflatable restraint system may be achieved in a variety of ways, many of which ultimately depend on the formula of the gas generating composition to provide the desired properties. Ideally, a gas generating composition provides sufficient gas mass flow in a desired time interval to achieve the required work impulse for an inflating device (e.g., airbag) within the inflatable restraint system. Although a temperature of the gas generated by the gas generating composition influences the amount of work gases can do, high gas temperatures may be undesirable because burns and related thermal damage can result. In addition, high gas temperatures can also potentially lead to an excessive reliance or sensitivity of the gas to heat transfer and excessively rapid deflation profiles, which can likewise be undesirable. Thus, minimizing flame temperature is advantageous.

The desired combustion flame temperature for a “fast and cool” gas generating composition used in a side inflatable restraint system is in the range of 1800 degrees K to 1950 degrees K (i.e., 1526.85 degrees C. to 1676.85 degrees C.). Thus, a high flame temperature may be considered anything in excess of about 1950 degrees K (1676.85 degrees C.) at combustion. In order to mitigate the effects of high flame temperatures, the inflator may include a heat sink that may also serve as a filter or screen for the inflator. But a significant portion of the mass of the inflator is often relegated to incorporation of the heat sink, which can impact the efficiency of the system and, more significantly, the weight of the inflator. In view of the above, an aspect that the present disclosure aims to provide is a gas generating composition for a side inflatable restraint system that can achieve a high gas output at a high mass flow rate at relatively low flame temperatures (i.e., less than approximately 1950 degrees K). This aspect is achieved by using a gas generating composition that includes at least one primary oxidizer, at least one secondary oxidizer, at least one primary fuel, and at least one secondary fuel. Although not required, the gas generating composition may also include various additives.

Primary Oxidizer

The gas generating compositions according to the present disclosure include at least one primary oxidizer. Example primary oxidizers that may be used in the gas generating compositions of the present disclosure include metal nitrates. Preferably, the at least one primary oxidizer includes a basic metal nitrate. The amount of primary oxidizer may range between about 25.00 to about 50.00% by weight, inclusive. Example basic metal nitrates include a basic copper nitrate, a basic cobalt nitrate, a basic zinc nitrate, a basic manganese nitrate, a basic iron nitrate, a basic molybdenum nitrate, a basic bismuth nitrate, and a basic cerium nitrate. Although more than one primary oxidizer can be used, it is particularly preferable that the primary oxidizer at least include a basic copper nitrate.

Secondary Oxidizer

The gas generating compositions of the present disclosure include at least one secondary oxidizer. The at least one secondary oxidizer may be present at amounts that range between about 1.00 to about 10.00% by weight, inclusive. Example secondary oxidizers include alkali metal and alkaline earth metal salts of perchloric acid. Specific examples of these materials that are suitable for use herein include ammonium perchlorate, sodium perchlorate, potassium perchlorate, magnesium perchlorate, and barium perchlorate. Although more than one secondary oxidizer can be used, it is particularly preferable that the secondary oxidizer at least include potassium perchlorate.

Primary Fuel

The gas generating compositions according to the present disclosure include at least one primary fuel. The at least one primary fuel may be present at amounts that range between about 35.00 to about 55.00% by weight, inclusive. Example primary fuels may include nitrogen containing organic compounds. In specific examples, the nitrogen containing organic compound may be guanidine or a guanidine derivative. The guanidine derivative can be selected from nitroguanidine, guanidine nitrate, aminoguanidine, aminoguanidine nitrate, copper bis guyanylurea dinitrate (CuGUN), and aminoguanidine hydrogen carbonate. Other examples of primary fuels include tetrazole or a tetrazole derivative selected from aminotetrazole, bitetrazole, azobitetrazole, nitrotetrazole, and nitroaminotetrazole. Although more than one primary fuel can be used, it is particularly preferable that the primary fuel at least include guanidine nitrate.

Secondary Fuel

The gas generating compositions according to the present disclosure include at least one secondary fuel. The at least one secondary fuel may be present at amounts that range between about 1.00 to about 10.00% by weight, inclusive. Any of the above-noted primary fuels may be used as the secondary fuel, albeit at a reduced amount in comparison to an amount of the primary fuel. Preferably, however, the secondary fuel at least includes melamine nitrate.

Additives

Although not required, the gas generating composition according to the present disclosure may contain at least one additive. If desired, the total amount of additive(s) contained in the gas generating compositions may range up to about 11.00% by weight. Additives may be used to cool gas temperature, improve slagging, improve effluents, improve binding, and improve powder flow. Additives for lubrication (i.e., press aids) can also optionally be added, which may permit improved powder flow during processing and pressing, and improve slagging.

Additives that may be used as a coolant to lower gas temperatures include materials such as basic copper carbonate or other suitable carbonates, copper glycolate, copper melamine oxalate, copper cyanurate dihydrate, and other suitable coolants.

Additives that may be used as a press aid include lubricants and/or release agents such as molybdenum disulfide and graphite, metal salts of fatty acids such as calcium stearate and magnesium stearate, and/or graphitic boron nitride, by way of non-limiting example. If used as an additive, press aids may be present in the gas generating compositions in amounts up to about 1% by weight.

Additives that may be used to improve slagging include metal oxides such as aluminum oxide, silicon dioxide, cerium oxide, ferric oxide, zinc oxide, titanium oxide, zirconium oxide, bismuth oxide, molybdenum oxide, lanthanum oxide, e-glass, and the like. Metal hydroxides such as aluminum hydroxide and other metal hydroxides known to one skilled in the art may also be used as an additive to improve slag. If used as an additive, slag generating agents may be present in the gas generating compositions in amounts up to about 10% by weight.

While in certain aspects it is preferred that the gas generating compositions are substantially free of binders, in certain alternate aspects, the gas generating compositions may include an additive that is a binding agent to improve crush strength, while not significantly harming effluent and burning characteristics. Example additives that may be used as a binding agent include carboxymethylcellulose, sodium carboxymethylcellulose, potassium carboxymethylcellulose, ammonium carboxymethylcellulose, cellulose acetate, cellulose acetate butyrate, methyl cellulose, ethyl cellulose, hydroxyethyl cellulose, ethylhydroxyethyl cellulose, hydroxypropyl cellulose, carboxymethylethyl cellulose, fine crystalline cellulose, polyacrylic amide, amine products of polyacrylic amide, polyacrylic hydrazide, a copolymer of an acrylic amide and a metal salt of acrylic acid, a copolymer of polyacrylic amide and polyacrylic ester compound, polyvinyl alcohol, acrylic rubber, guar gum, starch and silicone is proposed.

As noted above, the gas generating compositions according to the present disclosure preferably at least include potassium perchlorate as a secondary oxidizer and melamine nitrate as a secondary fuel. It has been found that the use of melamine nitrate in conjunction with potassium perchlorate achieves a synergistic effect on ballistics when these materials are used together, and where each of these materials are included in the gas generating compositions in amounts that range between about 1.00% by weight to about 10.00% by weight, inclusive. Preferably, each of these materials are included in the gas generating compositions in amounts that range between about 5.00% by weight to about 10.00% by weight, inclusive.

When a gas generating composition includes potassium perchlorate, the burn rate of a gas generating composition that includes potassium perchlorate may be a function of the amount of potassium perchlorate used. In addition, the amount of potassium perchlorate used may be proportional to the flame temperature. In other words, the burn rate and flame temperature increase with increasing amounts of potassium perchlorate in the gas generating composition. It would be expected, therefore, that if the amount of potassium perchlorate in the gas generating composition is reduced, the flame temperature can be cooled, while also reducing the amount of condensable potassium chloride gas that is generated as a combustion product (potassium chloride gas can pass through the filter of the inflator and condense to form a solid in the cushion, which is typically desired to be avoided to limit the amount of airborne particulates as required by vehicle manufacturers). Unfortunately, it has been learned that reducing the amount of potassium perchlorate in the gas generating composition reduces the burn rate to an extent that compositions using lower amounts of potassium perchlorate may not be useful in a side inflatable restraint system. This is evidenced by the below Table 1.

TABLE 1

| | Baseline | | | |
|---|---|---|---|---|
| Formulation | Comparison | 1 | 2 | 3 |
| % bCN | 28.47 | 36.26 | 36.01 | 35.63 |
| % Potassium | 12.52 | 6.78 | 6.98 | 6.98 |
| perchlorate | | | | |
| % Guanidine | 47.95 | 52.97 | 52.52 | 53.80 |
| nitrate | | | | |
| % Slag aid | 1.18 e | 0.75 e | 1.00 e | 1.00 e |
| | glass | glass | glass | glass |
| % Additive | 9.63 CuGUN | 2.99 Copper | 3.24 Copper | 2.34 Copper |
| (specify) | | glycolate | melamine | cyanurate |
| | | | oxalate | dihydrate |
| % Press aid | 0.25 Mg | 0.25 Ca | 0.25 Ca | 0.25 Ca |
| (specify) | stearate | Stearate | Stearate | stearate |
| Tc K | 2033 | 1921 | 1925 | 1926 |
| Rb@ 40 MPa | 62.03 | 48.15 | 48.80 | 49.05 |
| mm/sec | | | | |
| Slope | 0.54 | 0.42 | 0.41 | 0.42 |

Each of the above formulations were mixed and then spray-dried. As can be seen from the above Table 1, when the amount of potassium perchlorate in a side inflator formulation is reduced from 12.52% to less than 7%, the slope is reduced but the formulation does not generate enough burning rate to match the baseline comparison such that the reduced amount of potassium perchlorate would not be useful for a side inflator application.

As noted above, however, when reduced amounts of potassium perchlorate as the secondary oxidizer are used in conjunction with reduced amounts of melamine nitrate as the secondary fuel, a cool burning gas generant formulation is achieved that has a low burning rate slope and a burning rate sufficient to be useful in a side impact inflator application. In this regard, as can be seen from the below Table 2, the use of potassium perchlorate as the secondary oxidizer in a gas generant formulation that includes basic copper nitrate as the primary oxidizer and guanidine nitrate as the primary fuel significantly increases the burning rate of the formulation, but also significantly increases the pressure sensitivity of the burning rate, as can be seen when comparing Formulation 1 and Formulation 2 in Table 2.

TABLE 2
Effect of Additives on Burning Rate
of bCN/Guanidine Nitrate Formulation

| Formulation | 1 | 2 | 3 | 4 |
|---|---|---|---|---|
| % bCN | 46.62 | 30.51 | 49.10 | 36.82 |
| % Guanidine | 50.38 | 56.49 | 40.40 | 46.47 |
| nitrate | | | | |
| % Potassium | 0 | 10.00 | 0.00 | 8.76 |
| perchlorate | | | | |
| % Melamine | 0 | 0 | 7.50 | 7.46 |
| Nitrate | | | | |
| % Slag aid | 3.00 | 3.00 | 3.00 | 0.50 |
| Rb@ 40 MPa | 15.81 | 35.55 | 18.36 | 39.96 |
| *mm/sec | | | | |
| Slope | 0.37 | 0.54 | 0.39 | 0.40 |

Further, as can be seen in the above Table 2, the addition of melamine nitrate as a secondary fuel to the gas generant formulation that contains basic copper nitrate as the primary oxidizer and guanidine nitrate as primary fuel slightly increases each of the burning rate and the burning rate slope of the formulation, as can be seen when comparing Formulation 1 and Formulation 3 in Table 2. It can also be seen in Table 2, however, that when a combination of melamine nitrate and potassium perchlorate are added to a formulation containing basic copper nitrate as the primary oxidizer and guanidine nitrate as the primary fuel, the burning rate of Formulation 4 is greater than the that of Formulation 2. In addition, the slope achieved by Formulation 3 is preserved in Formulation 4, which shows a synergistic relationship between the use of melamine nitrate and potassium perchlorate at the reduced amounts (i.e., in amounts that range between about 1.00% by weight to about 10.00% by weight, and preferably in amounts that range between about 5.00% by weight to about 10.00% by weight, inclusive).

It should be understood that each of the formulations in Table 2 were made as sub-scale lab mixes that were not subsequently spray dried like the formulations in Table 1. Notwithstanding, the use of the sub-scale lab mixes are useful for relative comparison between formulations that do not contain potassium perchlorate and melamine nitrate (i.e., Formulation 1 in Table 2), formulations that contain each of potassium perchlorate and melamine nitrate (i.e., Formulation 4 in Table 2), and formulations that include one of potassium perchlorate (i.e., Formulation 2 in Table 2) and melamine nitrate (i.e., Formulation 3 in Table 2).

When Formulation 4 in Table 2 is spray dried, however, and compared to the baseline composition in Table 1, it can be seen that the flame temperature and slope are each reduced to an extent that is suitable for use in side impact inflator system as shown in Table 3 (below), while not sacrificing burn rate. In the formulations according to the present disclosure that include reduced amounts of potassium perchlorate and melamine nitrate, the burn rate is at least 50 mm/sec at 40 MPa and the slope is less than or equal to 0.40.

TABLE 3
Comparison of Spray Dried Formulation 4 in Table 2
to the Baseline Comparison Formulation in Table 1

| | Baseline | SD Mix 4 |
|---|---|---|
| Formulation | from Mix 1 | from Table 2 |
| % bCN | 28.47 | 36.73 |
| % guanidine nitrate | 47.95 | 46.35 |
| % potassium perchlorate | 12.52 | 8.74 |
| % Co-fuel | 9.63 CuGUN | 7.43 melamine |
| | | nitrate |
| % Slag Aid | 1.18 | 0.50 |
| % Press aid | 0.25 | 0.25 |
| Tc (K) | 2033 | 1950 |
| Burn Rate (@40 MPa) | 62.03 | 54.85 |
| Burn Rate Slope | 0.54 | 0.37 |

It should be understood that the amounts of various components of Formulation 4 in Table 2 have been reduced to account for the addition of a press aid that was required to spray dry the formulation.

As evidenced by the above, the formulations of the present disclosure that include reduced amounts of potassium perchlorate and melamine nitrate are beneficial in gas generant performance and reducing the overall cost of the system that includes the formulation. In this regard, the lower flame temperatures fall within the desired combustion flame temperature range for a “fast and cool” gas generant formulation that may be used in a side impact application (i.e., 1800K-1950K), and the burn rate of at least 50 mm/sec at 40 MPa and slope that is less than or equal to 0.40 allow for less required airbag cushion reinforcements and reduced wall thickness of the pressure vessel (combustion chamber), effectively reducing system cost and weight. Moreover, notwithstanding the lower flame temperature and burn rate slope, the burn rate remains at a level that is high enough to inflate the airbag cushion in the required time.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A gas generant formulation for a side impact airbag, the formulation comprising:
a primary fuel;
a primary oxidizer;
a secondary fuel that includes at least melamine nitrate, an amount of the melamine nitrate being in a range of about 1.00% by weight to about 10.00% by weight; and
a secondary oxidizer that includes at least potassium perchlorate, an amount of the potassium perchlorate being in a range of about 1.00% by weight to about 10.00% by weight,
wherein a burn rate of the formulation is at least 50 mm/sec at 40 MPa and a burn rate slope is equal to or less than 0.40.

2. The formulation according to claim 1, wherein the primary fuel includes at least guanidine nitrate.

3. The formulation according to claim 2, wherein an amount of the guanidine nitrate is in a range of about 35% by weight to about 55% by weight.

4. The formulation according to claim 1, wherein the primary oxidizer includes at least basic copper nitrate.

5. The formulation according to claim 4, wherein an amount of the basic copper nitrate is in a range of about 25% by weight to about 50% by weight.

6. The formulation according to claim 1, further comprising at least one additive in an amount up to about 11.0% by weight that is configured to cool a gas temperature yielded by the formulation, improve slagging of the formulation, or act as a press aid of the formulation.

7. The formulation according to claim 6, wherein the formulation includes an additive that improves slagging.

8. The formulation according to claim 7, wherein the additive that improves slagging includes at least one of a metal oxide and/or and a metal hydroxide.

9. The formulation according to claim 6, wherein the formulation includes an additive that is configured to act as a press aid.

10. The formulation according to claim 9, wherein the press aid includes at least one of a lubricant and/or a release agent.

11. The formulating according to claim 10, wherein lubricant includes at least one of molybdenum disulfide and graphite, and the release agent includes at least one of calcium stearate and magnesium stearate.

12. A gas generant formulation for a side impact airbag, the formulating comprising:
a primary fuel that includes at least guanidine nitrate;
a primary oxidizer that includes at least basic copper nitrate;
a secondary fuel that includes at least melamine nitrate, an amount of the melamine nitrate being in a range of about 5.00% by weight to about 10.00% by weight; and
a secondary oxidizer that includes at least potassium perchlorate, an amount of the potassium perchlorate being in a range of about 5.00% by weight to about 10.00% by weight,
wherein a burn rate of the formulation is at least 50 mm/sec at 40 MPa and a burn rate slope is equal to or less than 0.40.

13. The formulation according to claim 12, wherein an amount of the guanidine nitrate is in a range of about 35% by weight to about 55% by weight.

14. The formulation according to claim 12, wherein an amount of the basic copper nitrate is in a range of about 25% by weight to about 50% by weight.

15. The formulation according to claim 12, further comprising at least one additive in an amount up to about 11.0% by weight that is configured to cool a gas temperature yielded by the formulation, improve slagging of the formulation, or act as a press aid of the formulation.

16. The formulation according to claim 15, wherein the formulation includes an additive that improves slagging.

17. The formulation according to claim 16, wherein the additive that improves slagging includes at least one of a metal oxide and/or a metal hydroxide.

18. The formulation according to claim 15, wherein the formulation includes an additive that is configured to act as a press aid.

19. The formulation according to claim 18, wherein the press aid includes at least one of a lubricant and/or a release agent.

20. The formulation according to claim 19, wherein lubricant includes at least one of molybdenum disulfide and graphite, and the release agent includes at least one of calcium stearate and magnesium stearate.
